(19) United States
(12) Patent Application Publication
(10) Pub. No.: US 2025/0058575 A1
(43) Pub. Date: Feb. 20, 2025

(54) METHOD FOR PRINTING ON A WORKPIECE, PRINTING DEVICE AND COMPUTER PROGRAM

(71) Applicant: HOMAG GmbH, Schopfloch (DE)

(72) Inventors: Philipp HENRY, Ofterdingen (DE); Patrick MÜLLER, Glatten (DE); Boris THIESSEN, Rheda-Wiedenbrück (DE)

(21) Appl. No.: 18/719,242

(22) PCT Filed: Dec. 13, 2022
(86) PCT No.: PCT/EP2022/085544

§ 371 Date: Jun. 12, 2024

(30) Foreign Application Priority Data
Dec. 14, 2021 (DE) 10 2021 133 044.0

(51) Int. Cl. B41M 5/00; B41J 2/21; B41J 3/407; G06T 7/00; H04N 1/387

(52) U.S. Cl. CPC B41M 5/0088; B41J 2/21; B41J 3/4073; B41M 5/0076; G06T 7/0004; H04N 1/3871; G06T 2207/30164; G06T 2207/30168

(57) ABSTRACT

The present disclosure relates to a method for printing on a surface of a workpiece. The method can be performed using a digital printing process, and can include the steps of supplying to a printing controller a print template that is to be printed on the surface of the workpiece, supplying surface information related to the workpiece, and determining, on the basis of the print template and the surface information, printing information for actuating a printing unit Thereafter, the printing information can be transmitted to the printing unit, for printing the adapted print template on the surface of the workpiece.

### TECHNICAL FIELD

The invention relates to a method for printing on a surface of a workpiece, to a printing device for printing on a surface of a workpiece, and to a computer program.

### PRIOR ART

Workpieces, for example wood workpieces, the surfaces of which can be equipped with a coating material, often have a pattern printed on them for aesthetic reasons, for example a reproduction of a wood grain or the like. A pattern of this kind is printed on the surface of the workpieces by a printing device, for example in the form of a multicolor printing operation. In this regard, a surface to be printed on, for example a narrow face of the workpiece, can have different geometries, for example sloped, concave, or convex surface regions or differently configured surface regions such as chamfers or radii. Color deviations or optical distortions may occur in these regions in the print image and may compromise the print result.

### DESCRIPTION OF THE INVENTION

The problem addressed by the invention is to propose a method for printing on surfaces of workpieces by which a high-quality print result can be achieved. In addition, a problem addressed by the invention is to propose a printing device that allows workpieces to be printed on in an optimized and high-quality manner. The problem addressed by the invention is also to propose a computer program for adapting and supplying a print template in an optimized manner.

Claim 1 defines a method for printing on a surface of a workpiece. Claim 11 defines a printing device for printing on a surface of a workpiece. Claim 12 defines a computer program for adapting and supplying a print template. The dependent claims relate to particular embodiments.

The problem is solved by a method for printing on a surface of a workpiece, in particular by means of a digital printing process, comprising the steps of supplying to a printing controller a print template that is to be printed on the surface of the workpiece, supplying surface information related to the workpiece, said surface information including at least one geometric feature of the surface to be printed on, determining, on the basis of the print template and the surface information, printing information for actuating a printing unit by adapting the print template, at least in some regions, to the surface to be printed on in accordance with the surface information, transmitting the printing information to the printing unit, and printing the adapted print template on the surface of the workpiece.

Using a method of this kind, it is possible to adapt a print template that is to be printed on a surface of the workpiece specifically to surfaces to be printed on that have different geometric features. In this way, the print template, for example a surface pattern, can be matched to each surface in order to obtain a high-quality optical print image. Preferably, the surface to be printed on can be a narrow face of the workpiece.

In a preferred configuration of the method, the print template can be adapted only in a region corresponding to the at least one geometric feature.

Adapting the print template only in defined regions allows a smaller volume of data to be processed, thereby enabling fast data processing and thus a shorter printing operation.

In addition, an advantageous configuration of the method can provide that the print template is adapted to the at least one geometric feature in such a way that a print image, which has been printed on the surface of the workpiece, of the adapted print template is matched to the supplied print template in the region of the at least one geometric feature.

In this way, optical impairments in the print image are prevented particularly in the region of the at least one geometric feature, such that as faithful a representation of the supplied print template as possible can be printed on the particular surface.

A development of the method can provide that the print template is adapted to the at least one geometric feature by changing at least one ink feature, changing an image format, changing an image resolution, an image stretch, extracting an image region, and/or the like.

By adapting the print template in this way, optical distortions and/or color deviations in the print image, which may be caused by the at least one geometric feature, can be corrected beforehand. In this way, a homogenous and faithful representation of the print template can be printed on surfaces of different configurations.

Particularly advantageously, the at least one geometric feature can be supplied in the method as a configuration of an edge region, a contour, a slope, a cut-out, a hole, a coating, a seal, an insert, a connection, a display, and/or the like of the surface to be printed on.

By adapting the print template according to the at least one geometric feature and in particular also according to the contour, the print template can be adapted specifically to a configuration of the surface. Consequently, a high-quality print image can be printed on surfaces of any configuration.

The at least one geometric feature can be formed as a surface region, of the workpiece surface to be printed on, that is sloped, convex, concave, and/or recessed at least in some regions. Regions that are not to be printed on, for example cut-outs, holes, grooves, and the like, can be left out when printing on the surface. In this way, the printing operation can be provided as one of the last processing steps within a production process, and moreover printing ink can be saved.

Advantageously, it can be provided in the method that the surface information including the at least one geometric feature is supplied either from a workpiece dataset or by manual input.

As a result, the surface information can be supplied beforehand as a workpiece dataset, for example by a dataset from a workpiece manufacturer or by a machining device of a preceding machining step.

A further advantageous configuration of the method can provide that the surface information including the at least one geometric feature is acquired by an acquisition device. In this way, workpiece tolerances can also be taken into account and, where applicable, compensated for.

Preferably, the acquisition device can be formed as an optical system, for example as a camera system, a laser system, and/or a spectrophotometer. Electromagnetic systems (such as radar) are also possible. In this way, besides workpiece tolerances being compensated for particularly effectively, automation of the printing process can also be achieved.

Preferably, the method can provide that the supplying of the surface information, the adaptation of the print template, and/or the performance of the printing operation are carried out immediately one after the other and/or simultaneously, preferably in real time.

In this way, a time-optimized printing operation can be achieved, by which in particular the print template can be printed to a high quality on a plurality of workpiece surfaces having different geometric configurations. This leads to considerable cost reductions, in particular when printing on individual workpieces or small batches.

Another preferred configuration of the method can provide that a corresponding print detail to be printed on the surface of the workpiece is determined from the supplied print template in accordance with the supplied surface information.

This may be necessary in particular when adapting the print template using image stretch. In this case, a smaller or larger image detail can be determined from the print template depending on the surface information and is adapted to the corresponding surface in a precisely positioned manner using the image stretch.

A particularly advantageous configuration of the method can provide that a droplet size and/or droplet volume applied by the printing unit is/are adapted to a slope angle of the at least one geometric feature in relation to a printing plane.

Preferably, as the slope angle of the surface to be printed on increases, an increasing droplet size and/or droplet volume can be applied. In this way, a greater distance between droplets when printing on a sloped surface region can be compensated for. As a result, a distortion and/or a color deviation in the print image can be prevented.

In an advantageous development of the method, it can be provided that the print image of the adapted print template printed on the surface is acquired after the printing operation, and the adapted print template is matched to the print template supplied to the printing controller in accordance with the acquired print image and/or the surface information.

Acquiring the print image allows an inspection of the print result to be provided, and the adapted print template can be fine-tuned through feedback in accordance with the acquired print image.

In addition, the problem is solved by a printing device for printing on at least one surface of a workpiece, comprising at least one printing unit for performing a printing operation, and a printing controller for controlling the at least one printing unit, wherein a method according to one of the above-described embodiments can be carried out using the printing unit.

Preferably, the printing device is formed as a digital printing device by which in particular a multicolor printing operation can be performed. By way of example, the digital printing device can be an inkjet printing device that operates, for instance, according to the drop-on-demand principle. To perform the printing operation, the printing unit and/or the workpiece can be provided in a manner movable relative to one another. Using a printing device of this kind, a print template, for example a surface pattern, can be printed on specific surfaces of workpieces with a high-quality optical print image.

In addition, the problem is solved by a computer program according to claim 13.

Using a computer program of this kind, a print template can be adapted and supplied in an optimized manner in order to form a faithful representation of a print template on specific surfaces of workpieces.

### BRIEF DESCRIPTION OF THE DRAWINGS

Further features and advantages of an apparatus, a use, and/or a method become apparent from the following description of embodiments with reference to the accompanying drawings, in which:

FIG. 1 is a schematic view of a printing device for printing on a surface of a workpiece;

FIG. 2 is a schematic view of embodiments of workpiece surfaces to be printed on;

FIG. 3 is a schematic view illustrating a fundamental problem when printing on a surface of a workpiece;

FIG. 4 is a flowchart of a method for printing on a surface of a workpiece;

FIG. 5 is a graphical illustration of the method according to the flowchart in FIG. 4 on the basis of a print template and a workpiece surface to be printed on;

FIG. 6 is an example illustration of an adapted print template to be printed on a surface of a workpiece.

### DESCRIPTION OF EMBODIMENTS

The same reference numbers presented in various figures denote identical, corresponding, or functionally similar elements.

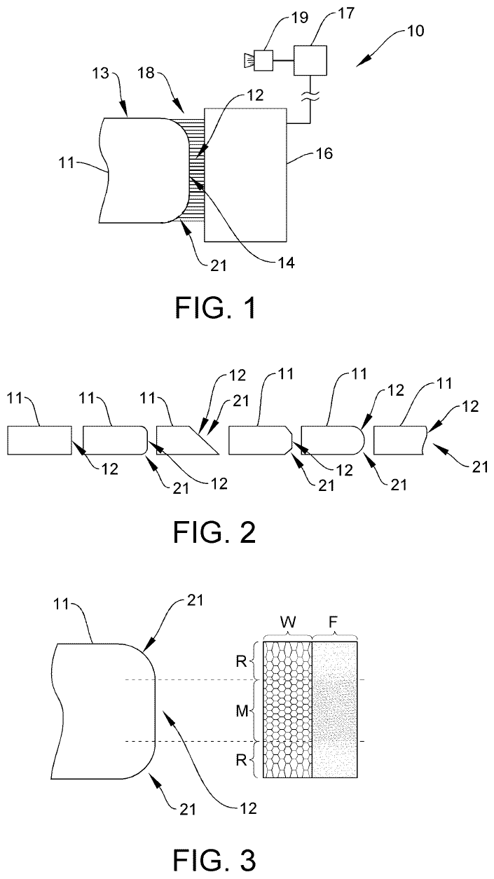

FIG. 1 is a highly schematic view of a printing device 10 for printing on workpieces 11, in particular workpieces 11 that are made at least in part of wood, a wood material, plastics material, a composite material, or the like.

Likewise, the workpieces 11 can be made of a stone material, a mineral material, a metal material, or the like.

Preferably, the workpieces 11 can be formed as board-like workpieces 11, for example as a solid wood board, chipboard, fiberboard, or the like. Such workpieces 11 can be intended for producing furniture or structural elements, for example.

Surfaces 12 of the workpiece 11, i.e., wide faces 13 and/or narrow faces 14 of the workpiece 11, can be equipped with a coating material, which can advantageously consist entirely or partly of plastics material. Using the printing device 10, the surfaces 12 of the workpiece 11, preferably the narrow faces 14 of the workpiece 11, can be printed on.

In particular, the printing device 10 is formed as a digital printing device by which a multicolor printing operation and/or single-color printing operation can be performed. Using a printing device 10 of this kind, both multicolor workpiece patterns, for example a reproduced wood grain, stone pattern, or the like, and single-color shades can be printed on the surfaces 12 of the workpiece 11. In this case, different text or markings such as barcodes can also be applied. For this purpose, the printing device 10 and/or the workpiece 11 can be movable relative to one another in one movement direction or in a plurality of movement directions.

The printing device 10 comprises a printing unit 16 for performing the printing operation, and a printing controller 17 for controlling the printing unit 16. The printing unit 16 comprises one or more print heads for applying printing ink 18.

The printing inks can be UV-based and/or water-based and/or solvent-based dyes, paints, primers, and/or inks.

The one or more print heads can be configured to apply a variable droplet size.

In addition, the printing device 10 can comprise an acquisition device 19 by which surface information of the workpiece 11 can be acquired. The acquisition device 19 can be an optical device, for example a camera device, a laser device, and/or a spectrophotometer. The acquired surface information is transmitted to the printing controller 17.

Alternatively or additionally, the surface information can be supplied to the printing controller 17 from a workpiece dataset, which is supplied for example as manufacturer specifications, or through manual input by a machine operator.

The surface information comprises at least one geometric feature 21 of the surface 12 to be printed on. As shown by way of example in FIG. 1, the geometric feature 21 is formed by a rounded edge region of the narrow face 14 of the workpiece 11.

This configuration of the geometric feature 21 is just one example embodiment, as illustrated by FIG. 2.

The geometric feature 21 can likewise be formed by a sloped surface 12, by one or more sloped surface regions on the surface 12, for example a chamfer, by an entirely rounded surface 12, by a surface 12 that is shaped concavely and/or convexly at least in some regions, or even by a planar surface 12 on which at least one geometric feature 12 is provided.

Likewise, the geometric feature 21 can be formed by a contour of the surface 12 to be printed on and/or as a cut-out, a hole, a coating, a seal, an insert, for example a threaded insert, a connection, a display, and/or the like on the surface 12.

FIG. 3 illustrates a fundamental problem with printing on surfaces 12 having a geometric feature 21, using the example of a rounded edge region.

On the left-hand side, FIG. 3 shows the workpiece 11 having the surface 12 to be printed on, which has two geometric features 21 in the form of rounded edge regions.

On the right-hand side, FIG. 3 shows a schematic print image of a pattern printed on the surface 12 by a standard printing operation. On the basis of the honeycomb structure W, this schematic print image illustrates an impairment to the print image caused by a distortion in the rounded edge regions of the surface 12 (top and bottom regions R) owing to the geometric features 21 by comparison with a print image that is faithfully reproduced on the planar surface region of the surface 12 (middle region M).

In addition, on the basis of the illustrated color progression F, FIG. 3 illustrates an impairment of the print image caused by a color deviation in the edge regions (top and bottom regions R) by comparison with the planar surface region (middle region M) resulting from the geometric feature 21.

The impairment to the print image owing to the distortion and the color deviation results from the fact that the ink droplets that hit a tilted plane during the printing operation come to rest further apart from one another than on a planar surface, resulting in the illustrated distortion and the illustrated color progression as the curvature of the edge region increases.

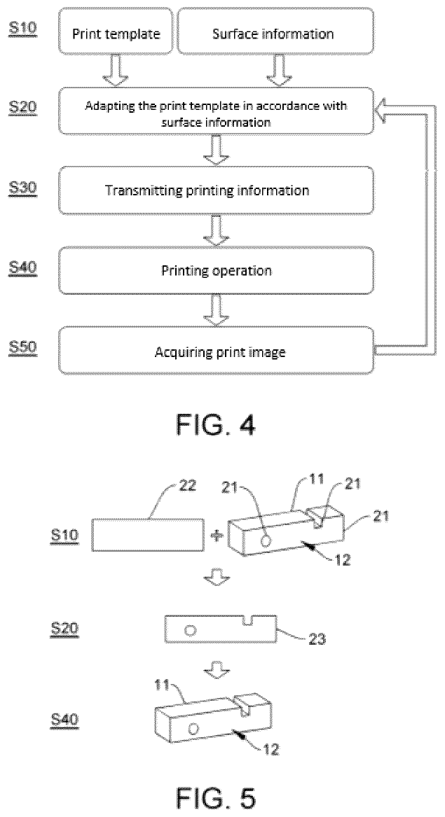

The method according to the disclosure for printing on surfaces 12 having one or more such geometric features 21 will now be explained on the basis of FIGS. 4 and 5. Using this method, a defined print template 22 can be printed on surfaces 12 having one or more geometric features 21 in the form of a high-quality print image. In this regard, FIG. 4 shows a flowchart of the method, and FIG. 5 shows a graphical illustration of the method according to the flowchart in FIG. 4 on the basis of a supplied print template 22 and an example workpiece 11 to be printed on.

Firstly, in a first step S10, the print template 22 to be printed on the surface 12 of the workpiece 11 and surface information that includes information concerning a plurality of geometric features 21 of the surface 12 to be printed on are supplied to the printing controller 17.

The supplied print template 22 forms a pattern template, for example having a wood grain, as illustrated in FIG. 5 according to step S10.

As also illustrated in FIG. 5 according to step S10, the surface information defines the surface 12 to be printed on having various geometric features 21. In FIG. 5, by way of example, these geometric features 21 define a contour delimiting the surface 12 and two cut-outs in the form of a hole and a groove that opens into the surface 12.

In a second step S20, a print template 23 adapted to the surface 12 to be printed on is determined by the printing controller 17 in the form of printing information for actuating the printing unit 16. For this purpose, the supplied print template 22 is adapted to the surface 12 to be printed on by the printing controller 17 on the basis of the surface information, taking the geometric features 21 into account. As illustrated in FIG. 5 according to step S20, the adapted print template 23 forms a geometric representation of the surface 12 to be printed on, taking the geometric features 21 into account.

As described above, the geometric features 21 can have different configurations. As a result, the supplied print template 22 is adapted to the particular geometric feature 21 in accordance with the form of that geometric feature 21.

In this case, the supplied print template 22 can be adapted to the particular geometric feature 21 in different ways. In particular, the supplied print template 22 is adapted to the particular geometric feature 21 by changing, at least in some regions, at least one ink feature, for example an ink volume and/or ink density, an image format, or an image resolution, by stretching the image at least in some regions, and/or by extracting an image region at least in some regions.

In this case, changing at least one ink feature at least in some regions involves changing at least a hue, a color saturation, a color contrast, a brightness, and/or the like.

Preferably, the supplied print template 22 is adapted by the printing controller 17 only in regions corresponding to the geometric features 21.

In a third step S30, the printing information determined by the printing controller 17 and corresponding to the adapted print template 23 is transmitted to the printing unit 16 in order to control the printing unit.

In a fourth step S40, the actual printing operation is performed, and the adapted print template 23 is printed on the surface 21 of the workpiece 11.

In an optional fifth step S50, after the printing operation, the adapted print template 23 can be fine-tuned or optimized by acquiring the print image of the adapted print template 23 printed on the surface 12. In this case, the print image can be acquired by the acquisition device 19 or by a different acquisition device and transmitted to the printing controller 17. Then, the printing controller 17 can match or optimize the adapted print template 23 in relation to the supplied print template 22 in accordance with the acquired print image and/or in conjunction with the surface information.

In the method described above by way of example, processing of the surface information and the adaptation of the print template were carried out in the printing controller 17. It is noted here that the printing controller should be understood broadly and that, for example, the print template can also be adapted spatially separately from the printing unit. In addition, it is possible within the context of the invention to process the surface information and adapt the print template independently of the printing controller. In this case, for example, use can be made of suitable image processing systems, and the adapted print template can then be transmitted to the printing controller in a suitable manner.

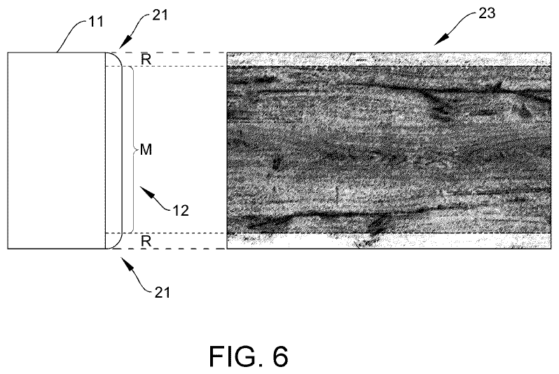

In addition, FIG. 6 shows a further example illustration of an adapted print template 23 to be printed on a surface 12 of a workpiece 11. This figure again illustrates the color adaptation and stretch of a print template 22 in the rounded edge regions (top and bottom regions R) by comparison with the planar surface region (middle region M), owing to the geometric features 21.

Consequently, the supplied print template 22 is adapted to the geometric features 21 of the surface 12 to be printed on in the above-described manner by the printing controller 17 by way of a stretch and a color adaptation, such that a print image, which has been printed on the surface 12 of the workpiece 11, of the adapted print template 23 is matched to the supplied print template 22 in the region of the geometric features 21.

In this case, the supplied print template 22 is stretched in accordance with a curvature of the edge regions of the surface 12. The greater the curvature of the corresponding region of the surface 12, the more the print template 22 is stretched. Owing to the stretch, the supplied print template 22 has to be made larger in terms of surface area than the surface 12 to be printed on. A stretch gradient of the print template 22 in the region of the geometric feature 21 is provided in the direction of a slope gradient of the surface 12 to be printed on. Alternatively, the stretch gradient can also be adapted to a viewing angle toward the geometric feature 21.

Likewise, the supplied print template 22 is adapted in terms of color in accordance with the curvature of the surface 12 in order to print a print image matched to the supplied print template 22 on the surface 12.

Additionally, a droplet size and/or droplet volume of the printing inks applied by the print heads can be adapted in accordance with the curvature of the surface 12. As a curvature of the surface 12 increases (in accordance with the slope gradient), an increasing droplet size and/or droplet volume can be applied. In this way, the problem of the greater distance between droplets when printing on a sloped surface 12 can be compensated for, and so too can the effect of the distortion and the color deviation.

It is self-evident to a person skilled in the art that individual features described in various embodiments can also be implemented in a single embodiment unless they would be structurally incompatible. Equally, different features described in the context of a single embodiment can also be provided in a plurality of embodiments separately or in any suitable sub-combination.

1. A method for printing on a surface of a workpiece, comprising the steps of:
supplying to a printing controller a print template that is to be printed on the surface of the workpiece;
supplying surface information related to the workpiece, said surface information including at least one geometric feature of the surface to be printed on;
determining, on the basis of the print template and the surface information, printing information for actuating a printing unit by adapting the print template, at least in some regions, to the surface to be printed on in accordance with the surface information; and
transmitting the printing information to the printing unit, and printing the adapted print template on the surface of the workpiece.

2. A method according to claim 1, wherein the print template is adapted only in a region corresponding to the at least one geometric feature.

3. A method according to claim 1, wherein the print template is adapted to the at least one geometric feature in such a way that a print image, which has been printed on the surface of the workpiece, of the adapted print template is matched to the supplied print template in the region of the at least one geometric feature.

4. A method according to claim 1, wherein the print template is adapted to the at least one geometric feature by changing at least one ink feature, changing an image format, changing an image resolution, an image stretch or, extracting an image region.

5. A method according to claim 1, wherein the at least one geometric feature is supplied as a configuration of an edge region, a contour, a slope, a cut-out, a hole, a coating, a seal, an insert, a connection, or a display, and/or the like of the surface to be printed on.

6. A method according to claim 1, wherein the at least one geometric feature is supplied either from a workpiece dataset or by manual input.

7. A method according to claim 1, wherein the at least one geometric feature is acquired by an acquisition device.

8. A method according to claim 1, wherein the supplying of the surface information, the adaptation of the print template, or the performance of the printing operation are carried out immediately one after the other, simultaneously, or in real time.

9. A method according to claim 1, wherein a corresponding print detail to be printed on the surface of the workpiece is determined from the supplied print template based on the supplied surface information.

10. A method according to claim 1, wherein a droplet size or droplet volume applied by the printing unit is adapted to a slope angle of the at least one geometric feature in relation to a printing plane.

11. A method according to claim 1, wherein the print image of the adapted print template printed on the surface is acquired and supplied after the printing operation, and the adapted print template s matched to the print template supplied to the printing controller based on the acquired print image or the surface information.

12. A printing device for printing on at least one surface of a workpiece, comprising at least one printing unit for performing a printing operation, and a printing controller for controlling the at least one printing unit, wherein the method of claim 1 can be carried out by the printing device.

13. A computer program for adapting and supplying a print template, in particular for a printing device according to claim 12, said computer program preferably being stored in a printing controller of the printing device.

14. A computer program according to claim 13, wherein the computer program is stored in a printing controller of the printing device.

15. A method according to claim 1, which is a digital printing process.
